(19) United States
(12) Patent Application Publication
(10) Pub. No.: US 2016/0343262 A1
(43) Pub. Date: Nov. 24, 2016

(54) Method and System for Generating a taxi routing of an aircraft in an airport area, related computer program product

(71) Applicant: Thales, Courbevoie (FR)

(72) Inventors: Rémy Auletto, Toulouse Cedex (FR); Johann Dreo, Palaiseau Cedex (FR); Pierre Saveant, Palaiseau Cedex (FR)

(21) Appl. No.: 14/977,284

(22) Filed: Dec. 21, 2015

(30) Foreign Application Priority Data
Dec. 19, 2014 (FR) 1402941

(51) Int. Cl. G08G 5/06; G08G 5/00; G01C 21/34

(52) U.S. Cl. CPC G08G 5/065; G01C 21/3438; G01C 21/3469; G01C 21/3492; G08G 5/0043

(57) ABSTRACT

A method for generating a taxi trajectory of an aircraft in an airport area includes the acquisition of a clearance including departure, arrival and intermediate elements of said area, the acquisition of a graph, and the determination, based on said graph, of entry and/or exit nodes for each element. It also includes the calculation, in the graph, of paths that are external to the elements and a path that is internal to each intermediate element, each external path connecting an exit node of one element to an entry node of the following element, each internal path connecting the entry node and exit node of said intermediate element, the paths calculated at first among the external and internal paths having a minimal cost; the calculation of a global path based on the internal path(s) and external paths and the generation of said taxi trajectory based on the global path.

### FIELD OF THE INVENTION

The present invention relates to a taxi trajectory generation method for generating a taxi trajectory of an aircraft in an airport area. The method is implemented by a computer, and includes:
the acquisition of a clearance including a departure element, an arrival element and at least one intermediate element of the airport area that the aircraft must follow between the departure element and the arrival element,
the acquisition of a graph corresponding to an airport navigation network, the navigation network being associated with the airport area, with said graph including a plurality of arcs, and each arc having two end nodes, and
the determination, based on the acquired graph, of at least one entry node and at least one exit node for each intermediate element of the clearance, of at least one departure node for the departure element and at least one arrival node for the arrival element.

The invention also relates to a non-transitory computer-readable medium including a computer program product that includes software instructions which, when they are executed by a computer, implement such a generation method.

The invention also relates to an electronic taxi trajectory generation system for generating a taxi trajectory of an aircraft in an airport area.

The invention relates in a general manner to the field of providing taxiing assistance to an aircraft in an airport area, the taxiing assistance being in particular effected in the form of a display, destined for the crew of the aircraft or an operator of a control tower, of the trajectory to be followed by the aircraft in the airport area, for example from the departure parking until take-off or indeed from landing until the arrival parking. Alternatively or in addition thereto, the taxi assistance is executed in the form of the forwarding to an onboard avionics system of the generated trajectory.

The invention relates to any aircraft that is likely to undertake taxiing in the airport area, in particular a civilian or military aircraft, for the transport of passengers or goods, or a drone, or even a helicopter.

The term taxi is used to refer to the movement of the aircraft in the airport area, the aircraft being in contact with the ground in the case of an airplane or a drone or indeed in close proximity to the ground in the case of a helicopter.

### BACKGROUND OF THE INVENTION

The document FR 2 924 829 A1 already discloses a known method of the aforementioned type and an associated taxi trajectory generation system for generating a taxi trajectory of an aircraft. The taxi trajectory generation system is capable of receiving a route comprising of a sequence of elements of the airport area that the aircraft must follow successively, and then extracting automatically from a set of reference points of the airport area the geographical coordinates of the reference points corresponding to the elements of the route that the aircraft must follow. The trajectory generation system is finally configured for calculating the taxi trajectory based on the extracted geographical coordinates, while also checking so as to ensure on the same trajectory that each turn presents a maximum curvature which is less than a predetermined threshold curvature.

However, the taxi trajectory generated by such a system is not optimal, the trajectory often being relatively long and/or high on fuel consumption.

### SUMMARY OF THE INVENTION

The purpose of the invention is therefore to provide a method and a system for generating a taxi trajectory that make it possible to improve the taxi trajectory generated, with the latter being for example shorter and/or promoting greater fuel-efficiency.

To this end, the invention relates to a method of the abovementioned type, wherein the process also includes:
the calculation in the acquired graph of a plurality of paths external to the elements of the clearance, and the calculation in the acquired graph of at least one path internal to each intermediate element of the clearance,

each external path connecting an exit node of an element of the clearance to an entry node of the element following said element in the clearance, each departure node forming an exit node and each arrival node forming an entry node,

each internal path connecting, for a corresponding intermediate element, the entry node and the exit node of said intermediate element, by passing through one or more arcs,

during the operation carried out at first among the calculation of the external paths and the calculation of the internal path(s), the calculated path(s) have, in accordance with a predetermined cost function, a minimum value;
the calculation of a global path between the corresponding departure nodes and arrival nodes, based on the calculated internal path(s) and external paths; and
the generation of the taxi trajectory based on the calculated global path.

According to other advantageous aspects of the invention, the taxi trajectory generation method includes one or more of the following features, taken into consideration singly or in accordance with all technically possible combinations:
the method includes several iterations between the determination of the entry node and exit node and the generation of the taxi trajectory, each iteration including a calculation of the external paths, a calculation of the internal paths and a calculation of the global path,

during a new iteration, a search is carried out for the new external and internal paths among the paths other than those calculated during the preceding iteration(s), and

over the course of the new iteration, during the operation carried out at first among said calculation of the internal path(s) and said calculation of external paths, the new calculated path(s) have, in accordance with the predetermined cost function, a minimum value among the values of said other paths, the calculation of the global path being then performed again for calculating a new global path based in addition on the new external and internal paths;
the new global path is retained only if it has, in accordance with the predetermined cost function, a value that is less than that of the global path calculated during the preceding iteration(s);
among the new external and internal calculated paths, only the path(s) used in the new global path are maintained, the other path(s) from said new external and internal paths being then ignored;
the calculation of the external paths is, at each iteration, carried out prior to the calculation of the internal path(s);
the calculation of the internal path(s) is, at each iteration, carried out prior to the calculation of the external paths;
the cost function associated with a path is selected from the group consisting in the curvilinear length of the path, the amount of fuel consumed on said path, a representative function of a congestion on said path, a representative function of a risk of accident on said path, a representative function of the travel time on said path and a function combining the above cited functions;
the acquisition of the graph includes the receiving of an initial airport navigation graph, said initial graph including a plurality of navigation arcs, each navigation arc having two end nodes and presenting at least one authorized direction of navigation;
the initial airport navigation graph then forms the acquired graph, the determination of the entry nodes and the exit nodes, the calculation of the external paths and internal path(s) and the calculation of the global path then being carried out based on the initial airport navigation graph;
the acquisition of the graph also includes:
   the determination of a conjugated node for each navigation arc and for each authorized direction of navigation of said arc, each conjugated node corresponding to a single authorized direction of navigation and representing said arc of the initial graph associated with said authorized direction of navigation, and
   the calculation of a conjugated graph including conjugated arcs connecting the conjugated nodes on the basis of the links between the arcs of the initial graph and the authorized directions of navigation, two conjugated nodes connected to each other corresponding to two successive arcs of the initial graph and to a single authorized direction of navigation, and
   the conjugated graph then forms the acquired graph, the determination of the entry and the exit nodes, the calculation of the external paths and internal path(s) and the calculation of the global path then being carried out based on the conjugated graph;
the acquisition of the graph also includes the classification of the conjugated nodes determined into first and second distinct subsets, the first subset including the conjugated node(s) corresponding to the arcs that are navigable for any clearance and the second subset including the conjugated nodes corresponding to the arcs that are navigable only for one or more clearances;
the conjugated nodes corresponding to a single element of the clearance are also grouped together with each other; and
the method includes the acquisition of at least one variable value relative to an aircraft considered from among the weight of the aircraft and at least one dimension relative to the bulk of the aircraft,

during the determining of the conjugated nodes, a conjugated node is determined for a respective arc only if said arc is compatible with the acquired variable value.

The invention also relates to a non-transitory computer-readable medium including a computer program product comprising software instructions which, when they are executed by a computer, implement a trajectory generation method as defined here above.

The invention also relates to an electronic taxi trajectory generation system for generating a taxi trajectory of an aircraft in an airport area, the system comprising:
a first clearance acquisition device configured for acquiring a clearance including a departure element, an arrival element and at least one intermediate element of the airport area that the aircraft must follow between the departure element and the arrival element,
a second acquisition device configured for acquiring a graph corresponding to an airport navigation network, the navigation network being associated with the airport area, with said graph including a plurality of arcs, and each arc having two end nodes,
a node determining device for determining, based on the acquired graph, at least one entry node and at least one exit node for each intermediate element of the clearance, of at least one departure node for the departure element and at least one arrival node for the arrival element,

the system also includes:
a first computing device configured for calculating, in the acquired graph, a plurality of external paths that are external to the elements of the clearance and at least one internal path that is internal to each intermediate element of the clearance, each external path connecting an exit node of an element of the clearance to an entry node of the element following said element in the clearance, by passing through one or more arcs, each departure node forming an exit node and each arrival node forming an entry node, each internal path connecting, for a corresponding intermediate element, the entry node and exit node of said intermediate element, by passing through one or more arcs,

the path(s) calculated at first among the external paths, on the one hand, and the internal paths, on the other hand, having a minimum value in accordance with a predetermined cost function,
a second computing device configured for calculating a global path between the corresponding departure nodes and arrival nodes, based on the internal path(s) and external paths calculated by the first computing device, and
a taxi trajectory generation device for generating of the taxi trajectory based on the global path calculated by the second computing device.

### BRIEF DESCRIPTION OF THE DRAWINGS

These features and advantages of the invention will become apparent upon reviewing the description that will follow, provided only by way of a non-limiting example and with reference to the attached drawings, in which:

FIG. 1 is a schematic representation of an electronic system, according to the invention, for generating a taxi trajectory of an aircraft in an airport area;

FIG. 2 is a partial schematic view of the airport area and the airport navigation network associated with this airport area;

FIGS. 3 to 7 are schematic views illustrating the generation of the taxi trajectory for a clearance including one departure element, three intermediate elements and one arrival element; and

FIG. 8 is a flow chart of a method, according to the invention, for generating the taxi trajectory of the aircraft.

### DETAILED DESCRIPTION OF PREFERRED EMBODIMENTS

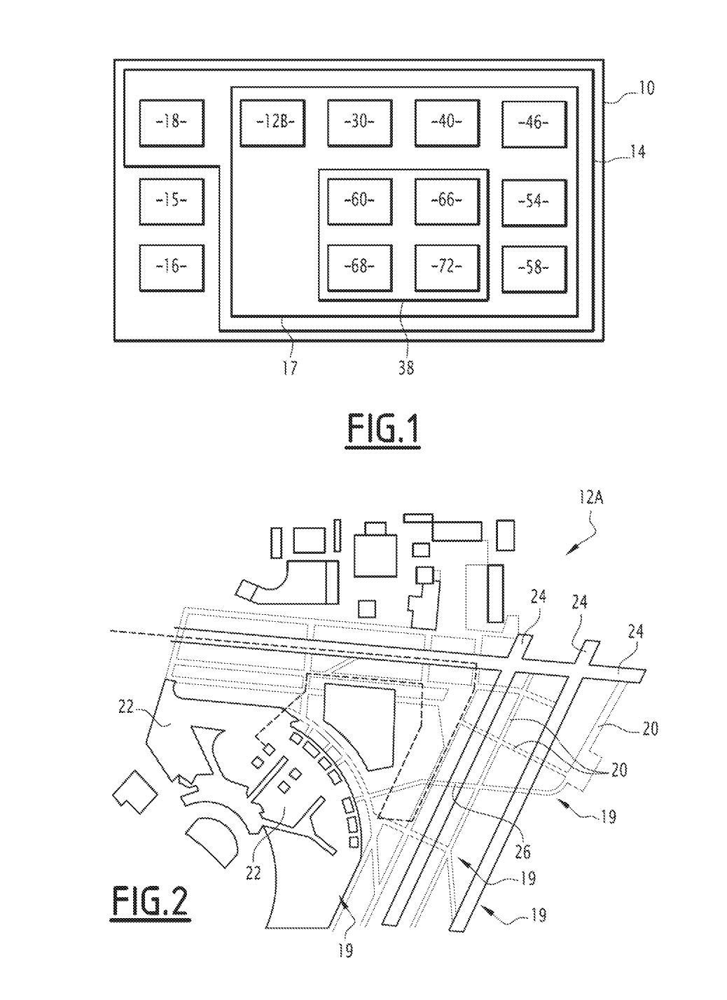

Represented in FIG. 1 is an electronic taxi trajectory generation system 10 for generating a taxi trajectory 11 of an aircraft, not shown, in an airport area 12A, the airport area 12A being associated with an airport navigation network 12B.

The trajectory generation system 10 includes an information processing unit for processing data and information 14, a display screen 15 and the data input means 16, the information processing unit 14 being formed for example by a memory 17 and a processor 18 associated with the memory 17.

The airport area 12A, an example of which is visible in FIG. 2, includes various different airport elements 19, in particular the taxiways 20, the parking spaces 22, one or more runway strips 24 and one or more runway crossings 26.

The navigation network 12B is in conformity with the standards of the European Organisation for Civil Aviation Equipment EUROCAE ED99C and EUROCAE ED119B or with the more recent versions of these standards. The navigation network 12B forms a model of the entire airport area 12A. The navigation network 12B includes navigation arcs, which are not represented.

The memory 17 is capable of storing the airport navigation network 12B.

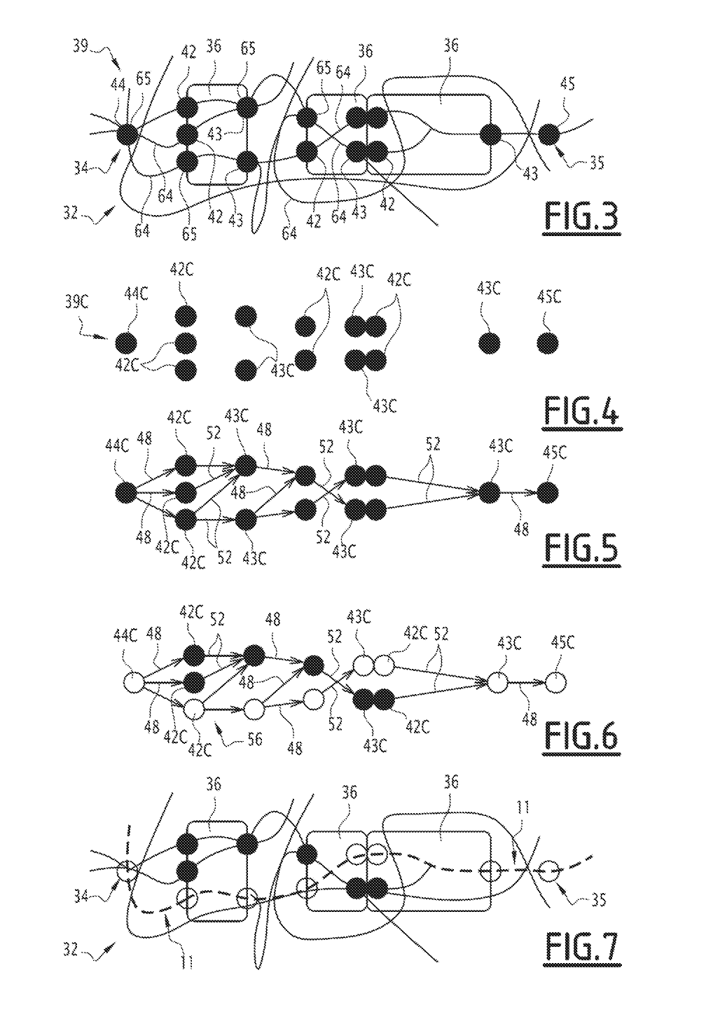

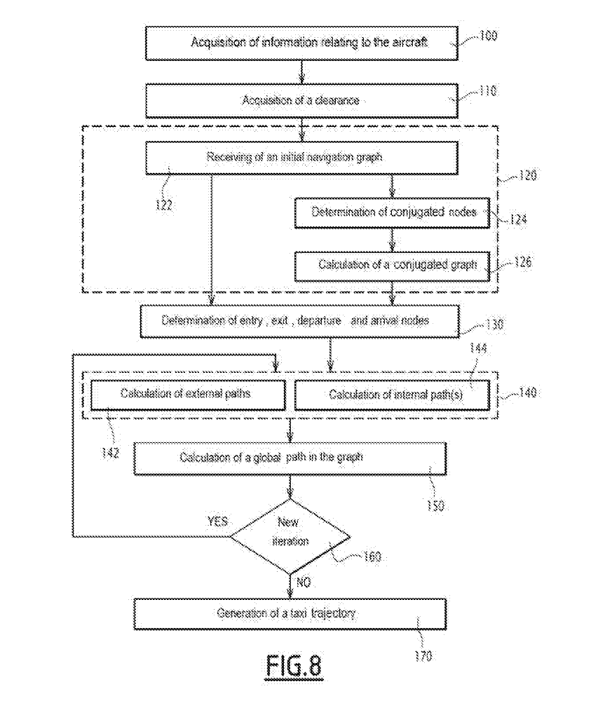

The memory 17 is also capable of storing a first clearance acquisition software application 30 for acquiring a clearance 32, the clearance 32 including a departure element 34, an arrival element 35 and at least one intermediate element 36 of the airport area that the aircraft must follow between the departure element 34 and the arrival element 35, visible in the FIGS. 3 and 7.

The memory 17 is also capable of storing a second graph acquisition software application 38 for acquiring an airport navigation graph 39, 39C corresponding to the airport navigation network 12B, the graph acquired being an initial airport navigation graph 39 received by the trajectory generation system 10 or even a conjugated graph 39C calculated based on the initial airport navigation graph 39 received.

The memory 17 is also capable of storing a node determination software application 40 for determining, based on the acquired graph 39, 39C, at least one entry node 42 and at least one exit node 43 for each intermediate element 36 of the clearance, of at least one departure node 44 for the departure element 34 and at least one arrival node 45 for the arrival element 35.

The memory 17 is also capable of storing a first calculation software application 46 for computing, in the acquired graph 39, 39, of a plurality of paths 48 external to the elements 34, 35, 36 of the clearance, and at least one path 52 internal to each intermediate element 36 of the clearance, the path(s) calculated at first among the external paths, on the one hand, and the internal path(s), on the other hand, having a minimum value in accordance with a predetermined cost function.

The cost function associated with the path is, for example, the curvilinear length of the path. Alternatively, the cost function associated with the path is the amount of fuel consumed when the aircraft traverses the path. Alternatively, the cost function associated with the path is the time of travel across said path by the aircraft, that is to say, the period of time elapsing while the aircraft travels across the path. Alternatively, the cost function associated with the path is a representative function of route congestion associated with said path. Alternatively, the cost function associated with the path is a representative function of a risk of accident on said path.

The memory 17 is also capable of storing a second calculation software application 54 for computing of a global path 56 between the corresponding arrival 44 and departure nodes 45 based on the internal path(s) 52 and the external paths 48 calculated by the first calculation software application 46.

The memory 17 is also capable of storing a taxi trajectory generation software application 58 for generating of the taxi trajectory 11 based on the global path 56 computed by the second calculation software application 54.

The processor 18 is capable of executing each of the respective software applications for acquisition 30, 38, determination 40, calculation 46, 54 and generation 58.

The first acquisition software application 30, the second acquisition software application 38, the determination software application 40, the first calculation software application 46, the second calculation software application 54, and the generation software application 58, respectively form, when they are executed by the processor 18, a first electronic clearance acquisition device, a second electronic graph acquisition device, an electronic node determination device for determining the entry, exit, departure and arrival nodes, a first electronic path calculation device for calculating the external paths and the internal path(s), a second electronic path calculation device for calculating of the global path, and an electronic trajectory generation device for generating of the taxi trajectory path.

Alternatively, the first acquisition device 30, the second acquisition device 38, the determination device 40, the first calculation device 46, the second calculation device 54 and the generation device 58 are made in the form of programmable logic components, or even in the form of dedicated integrated circuits.

The first acquisition device 30 is configured for acquiring the clearance 32, the latter having previously been input by a member of the crew of the aircraft via the data input means 16, or indeed received in the form of a data file sent by an avionics equipment unit, which is not represented or even received directly from a control tower via radio transmission.

The acquired clearance 32 includes the departure element 34, the arrival element 35 and the intermediate element or elements 36. In other words, the clearance 32 includes an ordered sequence of elements 19 of the airport area that the aircraft must follow successively. In the example shown in FIG. 3, the clearance 32 includes three intermediate elements 36, referenced respectively with the letters A, B and C.

The departure node(s) 44 Correspond by default to the points that are closest to the current position of the aircraft. The arrival node(s) 45 are generally entry points in an arrival element 35 that often is a parking space when the taxi trajectory 11 happens to follow the landing of the aircraft, or indeed a corresponding runway strip 24 when the taxi trajectory 11 happens to precede the take-off of the aircraft.

Each intermediate element 36 is associated with a zone of the navigation network 12B. The intermediate element or elements 36 generally correspond to an ordered list of intermediate taxiways of the airport area 12A.

The second acquisition device 38 is configured for acquiring the graph 39, 39C based on which the entry 42, exit 43, departure 44 and arrival 45 nodes are determined, and then in which the internal path(s) 52 and external paths 48 are calculated, and finally in which the global path 56 is calculated.

The second acquisition device 38 includes a reception module 60 for receiving the initial airport navigation graph 39, which is visible in FIG. 3. The initial graph 39 includes a plurality of arcs of navigation 64, each navigation arc 64 including two end nodes 65. Each navigation arc 64 presents at least one authorized direction of navigation, and is identified in particular by its two end nodes 65 and the material geometric rendering thereof. The initial airport navigation graph 39 is also known as airport connectivity graph, or even ASRN graph (abbreviation from the English term Aerodrome Surface Trajectory Network). This initial graph 39 represents in other words all of the routes usable by the aircraft in the airport. The arcs 64 and 65 and the end nodes are labeled in a manner so as to be able to be linked to the airport elements used in the clearances 32. The initial graph 39 for example, is in conformity with the standard ED 99-C/DO272-C and by extension with the standard ARINC 816-2, or more recent versions of these standards.

As an optional addition, the second acquisition device 38 includes an information acquisition module 66 for acquiring of information relative to the aircraft, such as a minimum bending radius corresponding to the maximum steering limits of the aircraft, the weight of the aircraft and/or at least one dimension relative to the bulk, such as wing span of the aircraft, and the height of the aircraft.

According to a first example, the initial graph received 39 then forms the graph acquired by the second acquisition device 38. The determination device 40 is then capable of determining the entry 42, exit 43, departure 44 and arrival 45 nodes based on the initial graph 39, and the first calculation device 46 and the second calculation device 54 are capable of calculating the internal path(s) 52 and external paths 48, and the global path 56 respectively, in said initial graph 39.

According to a second example, the second acquisition device 38 also includes a node determination module 68 for determining a conjugated node for each navigation arc 64 and for each authorized direction of navigation of said arc. Each conjugated node corresponds to a single authorized direction of navigation. Each conjugated node then represents said arc 64 of the initial graph associated with said authorized direction of navigation.

According to the second example, the second acquisition device 38 also includes a graph calculation module 72 for computing the conjugated graph 39C, the calculation module 72 being configured in order to connect the conjugated nodes on the basis of the links between the arcs 64 of the initial graph 39 and the authorized directions of navigation, two conjugated nodes connected to each other corresponding to two successive arcs 64 of the initial graph and to a single authorized direction of navigation.

According to the second example, the conjugated graph 39C thus forms the graph acquired by the second acquisition device 38. The node determination device 40 is then capable of determining the entry 42, exit 43, departure 44 and arrival 45 nodes based on the conjugated graph 39C, the first calculation device 46 and the second calculation device 54 then being able to calculate the internal path(s) 52 and external paths 48 and respectively the global path 56 in said conjugated graph 39C.

The receiving module 60, the acquisition module 66, the determination module 68 and the calculation module 72 are each developed in the form of a software function included in the second acquisition software application 38 and able to be executed by the processor 18.

Alternatively, the receiving module 60, the acquisition module 66, the determination module 68, and the calculation module 72 are developed in the form of programmable logic components, or in the form of dedicated integrated circuits.

The determination device 40 is configured in order to determine, for each intermediate element 36 of the clearance acquired by the acquisition device 30, the entry node(s) 42 and the exit node(s) 43 of said intermediate element 36. The determination device 40 is also configured in order to determine, on the one hand, the departure node(s) 44 for the departure element 34, and on the other hand, the arrival node(s) 45 for the arrival element 35.

According to the first example, when the acquired graph is the initial airport navigation graph 39, the determination device 40 is, for example, configured in order to, when the initial graph 39 for example, is in conformity with the standard ED 99-C or more recent versions thereof or indeed with the standard ARINC 816-2, or more recent versions deriving therefrom, determine the entry 42, exit 43, departure 44 and arrival 45 nodes directly based on the initial graph 39, the latter containing for each airport element, the data and information relating to the nodes for entry in said element and for exit from said element. More precisely, the initial airport navigation graph 39 includes a transition identifier for each navigation arc 64 corresponding to a transition between two elements of the airport area 12A that are likely to belong to a clearance.

The determination device 40 is then configured in order to search for the transition identifiers associated with the elements of the clearance 32 acquired, and to infer therefrom said entry 42, exit 43, departure 44 and arrival 45 nodes, visible in the FIG. 3, based on the direction of movement from the departure element 34 to the arrival element 35 of the clearance acquired 32.

According to the second example, the determination device 40 is configured in order to determine the entry 42, exit 43, departure 44 and arrival 45 nodes based on the calculated conjugated graph 39C, each entry 42, exit 43, departure 44 and arrival 45 node corresponds to a conjugated node, and is then also known as conjugated entry node 42C, conjugated exit node 43C, conjugated departure node 44C and conjugated arrival node 45C respectively. Each conjugated node corresponds to a single authorized direction of navigation, the determination device 40 is then configured in order to determine said conjugated entry 42C, exit 43C, departure 44C and arrival 45C nodes, visible in the FIG. 4, based, on the one hand, on the single authorized direction of navigation associated with each of the conjugated nodes, and on the other hand, on the direction of travel from the departure element 34 to the arrival element 35 of the acquired clearance 32.

By convention, in the description, the conjugated nodes calculated by the calculation module 72 are denoted by the general reference numerals, and among said conjugated nodes, those that correspond in particular to the entry into a respective intermediate element 36, to the exit from a respective intermediate element 36, to the departure element 34 and to the arrival element 35 respectively are denoted by the respective reference numerals 42C, 43C, 44C, and 45C, as represented in FIGS. 4 to 6.

In the following of the description, for all the aspects relating to the calculation of the external paths 48 and internal path(s) 52 and the calculation of the global path 56, the terms <<entry node>>, <<exit node>>, <<departure node>>, and <<arrival node>> will designate the entry node 42, the exit node 43, the departure node 44, and arrival node 45 when the acquired graph is the initial airport navigation graph 39, and respectively the conjugated entry node 42C, the conjugated entry node 43C, the conjugated departure node 44C, and the conjugated arrival node 45C, when the acquired graph is the conjugated graph 39C.

The first calculation device 46 is configured for calculating, in the acquired graph 39, 39C, the external paths 48 and the internal path(s) 52. Each calculated external path 48 connects an exit node 43, 43C associated with an element of the clearance to an entry node 42, 42C associated with the element following said element in the clearance, by passing through one or more arcs, each departure node 44, 44C forming an exit node 43 43C, and each arrival node 45, 45C forming an entry node 42, 42C, as represented in the FIG. 5. Each calculated internal path 52 connects, for a corresponding intermediate element 36, the entry nodes 42, 42C and the exit nodes 43, 43C to said intermediate element 36 by passing through one or more arcs.

The first calculation device 46 is also configured so that the paths calculated at first among the external paths 48, on the one hand, and the internal path(s) 52, on the other hand, have, in accordance with a predetermined cost function, a minimum value. In other words, the first computing device 46 is configured for calculating the shortest paths for those calculated at first among the external paths 48, on the one hand, and the internal paths 52, on the other hand.

The first calculation device 46 is then configured so that the paths calculated second among external paths 48, on the one hand, and the internal paths 52, on the other hand, are compatible with the shortest path(s) calculated at first, that is to say they connect the entry nodes 42, 42C and exit nodes 43, 43C belonging to the shortest paths calculated at first.

In the following of the description, the term transition is used to refer to any transfer passing:
i) from the departure node(s) 44, 44C to the entry node(s) 42, 42C related to the first intermediate element 36 gained clearance,
ii) from the exit node(s) 43, 43C associated with an intermediate element 36 of the clearance to the entry node(s) 42, 42C associated with the element following said intermediate element 36 in the clearance,
iii) from the exit node(s) 43, 43C associated with the last intermediate element 36 of the clearance acquired to the arrival node(s) 45, 45C, or even
iv) from the entry node(s) 42, 42C associated with a given intermediate element 36 to the exit node(s) 43, associated with this intermediate element 36 43C.

The person skilled in the art will thus understand that the first computing device 46 is configured for calculating the external paths 48 among the transitions of type i), ii) and iii), and to calculate the internal path(s) 52 among the transition or transitions of type iv).

As an optional addition, the first computing device 46 is configured for calculating a plurality of external paths 48 and/or internal paths 52 respectively for at least one transition. In other words, the first computing device 46 is configured for calculating multiple shortest paths for at least one transition. The plurality of external paths 48 and/or internal paths 52 respectively calculated for the relevant transition concerned is then all of the paths with the minimum values for said transition in accordance with a predetermined cost function. Multiple paths 48, 52 have, for example, in accordance with a predetermined cost function, a single minimum value for a given transition.

The path(s) 48, 52 corresponding to the minimum value of the predetermined cost function for a given transition, or according to the optional addition the paths corresponding to the minimum values of said cost function for this transition, are for example calculated via an algorithm, known per se, for searching for the shortest path in a graph, such as Dijkstra's algorithm, the DLU algorithm or even the A* algorithm. For the calculation of the external path 48 or internal path 52, Dijkstra's algorithm will preferably be used.

The second calculation device 54 is configured for calculating the global path 56 between the corresponding departure and arrival nodes from the internal path(s) 52 and external paths 58 calculated by the first calculation device 46, as shown in FIG. 6 where the global path 56 is the one passing through the hatched nodes. More precisely, the global path 56 is then formed only by internal path(s) 52 and external paths 58 previously calculated by the first computing device 46. The global path 56, in a manner analogous to the internal path(s) 52 and external paths 58, is calculated via an algorithm, known per se, for searching for the shortest path, such as Dijkstra's algorithm, the DLU algorithm or even the A* algorithm. For the calculation of the global path 56, the A* algorithm will preferably be used.

The generation device 58 is then configured in order to generate the taxi trajectory of 11, also known as taxi routing, or taxi route, visible in the FIG. 7, based on the global path 56 calculated by the second calculation device 54. In other words, the generation device 58 is configured in order to reconstruct the trajectory in the airport area 12A passing through the corresponding navigation arcs 64, in the initial graph 39 according to the first example, or in the conjugated graph 39C according to the second example, to the calculated global path 56.

The generation device 58 is also capable of transmitting the taxi trajectory 11 generated to the display screen 15 in order to ensure that the display thereof is available to the crew of the aircraft or to an operator in a control tower. Alternatively or in complement thereto, the generation device 58 is capable of transmitting the taxi trajectory 11 generated to an on-board avionics system.

According to the second example, the determination module 68 is configured in order to determine, for each navigation arc 64 and for each authorized direction of navigation of said arc, the corresponding conjugated node.

According to the second example, as an optional addition, the determination module 68 is configured in order to classify the conjugated nodes into first and second distinct subsets, which are not shown in FIG. 5. The first subset includes the conjugated node(s) corresponding to the arcs that are navigable for any clearance. In other words, the first subset comprises the conjugated node(s) corresponding to the arcs that are navigable regardless of the clearance acquired by the acquisition device 30. The second subset includes the conjugated node(s) corresponding to the arcs that are navigable only for one or more clearances. In other words, the second subset includes the conjugated node(s) corresponding to the arcs whose use is conditioned on the clearance, that is to say, whose use depends upon the clearance. The first subset includes for example, the conjugated nodes corresponding to the arcs associated with the taxiways. The second subset includes, for example, the conjugated nodes corresponding to the arcs associated with the runway crossings of the airport area and/or the conjugated nodes corresponding to the arcs associated with the parking spaces in the airport area.

According to the second example, as an optional addition, the determination module 68 is configured in order to determine a conjugated node in relation to a respective arc 64 of the initial graph 39 only if said arc is compatible with each dimension of the aircraft acquired by the acquisition module 66, such as the wing span and/or the height of the aircraft.

According to the second example, as an optional addition, the determination module 68 is configured in order to determine a conjugated node in relation to a respective arc 64 of the initial graph 39 only if said arc is compatible with the weight of the aircraft acquired by the acquisition module 66.

According to the second example, as an optional addition, the determination module 68 is configured in order to associate with each conjugated node a value of the corresponding arc 64 in accordance with a predetermined cost function.

According to the second example, the calculation module 72 is configured for calculating the conjugated graph by connecting the conjugated nodes on the basis of the links between the arcs of the initial graph 39 and the authorized directions of navigation, two conjugated nodes connected to each other corresponding to two successive arcs 64 of the initial graph and to a single authorized direction of navigation. Each conjugated node corresponds to a single airport element and to a single authorized direction of navigation.

According to the second example, as an optional addition, the calculation module 72 is configured in order to connect two conjugated nodes to each other only when the two successive arcs 64 of the initial graph, represented by said conjugated nodes, form between them a bending radius that is greater than the minimum bending radius of the aircraft acquired by the acquisition module 66.

According to the second example, as an optional addition, the calculation module 72 is configured in order to remove a conjugated node having one single preceding conjugated node and one single subsequent conjugated node, the preceding conjugated node and the subsequent conjugated node being then connected directly to each other. The deleted conjugated node does not provide any pertinent functional information in addition to the information already provided by said preceding and subsequent conjugated nodes.

According to the second example, as an optional addition, the calculation module 72 is configured in order to remove a conjugated node corresponding to a dead end arc if said dead end arc does not correspond to an element of the clearance, and in particular not to the point of departure or point of arrival of the clearance. A conjugated node corresponding to a dead end arc is a conjugated node having only one or more preceding conjugated nodes, or indeed having only one or more subsequent conjugated nodes, along the authorized direction of navigation associated with said conjugated node. In other words, according to this optional addition the calculation module 72 is configured in order to remove a conjugated node that has no preceding conjugated node or indeed has no subsequent conjugated node, along the authorized direction of navigation associated with said conjugated node, and if said conjugated node does not correspond to an element of the clearance.

The operation of the taxi trajectory generation system 10 according to the invention will now be explained according to the FIG. 8 representing a flowchart of the method, according to the invention, for generating the taxi trajectory of the aircraft 11.

During an optional initial step 100, the acquisition module 66 acquires the information relating to the aircraft. In the case of acquisition of information relating to the aircraft, these comprise, for example, the minimum bending radius corresponding to the maximum steering limits of the aircraft, also known as minimum turning radius of the aircraft, at least one dimension relative to the bulk, such as wing span of the aircraft, and/or its height, and/or even the weight of the aircraft.

The first acquisition device 30 acquires, during the step 110, the clearance 32, the latter includes an ordered sequence of airport elements 19 that the aircraft must follow successively, in particular the departure element 34, the arrival element 35 and generally one or more intermediate elements 36 of the airport area 12A between the departure element 34 and the arrival element 35.

The second acquisition device 38, during the step 120, acquires the graph 39, 39C that will be used subsequently to calculate internal path(s) 52 and external paths 52 58 and the global path 56.

The acquisition step 120 includes the reception 122 of the initial airport navigation graph 39 by the receiving module 60, said initial graph 39 originating for example from an airport database. The initial graph 39 received contains the entire set of navigation arcs 64 associated with the airport navigation network 12B, each navigation arc 64 being for example in the form of a sequence of points, that is to say, the end nodes 65 and the intermediate points comprised between these end nodes 65. Each navigation arc 64 presents one or two authorized direction(s) of navigation depending on whether the arc considered 64 is mono-directional or bi-directional, and whether it is identified by its two end nodes 65. The couple of end-nodes 65 representing each arc 64 is also associated in a preferential manner, with a value for said arc 64 in accordance with a predetermined cost function.

According to the first example, at the end of reception of the initial graph 39 122, the process goes directly to a step 130 (as represented by the segment shown in dotted line in FIG. 8), during which the entry 42, exit 43, departure 44 and arrival 45 nodes are determined based on the graph acquired, that is to say based on the initial graph received 39 in this case. In other words, the acquisition step 120 includes, according to the first example, only the receiving of the initial graph 39 122.

According to the second example, the acquisition step 120 also includes the determination 124 of the conjugated node for each navigation arc 64 and for each authorized direction 44 associated with said arc. Each conjugated node then corresponds to a single authorized direction 44 of navigation, and represents said arc 64 of the initial graph associated with said authorized direction 44.

As an optional addition to the second example, during said determination step 124, the conjugated nodes determined are classified into separate and distinct first and second subsets. The first subset, also known as permanent sub-graph, includes the conjugated nodes corresponding to the arcs 64 that are navigable for any clearance. It mainly includes all of the taxiways 20 of the airport. The second subset, also known as optional sub-graph, forms the complement to the permanent sub-graph, and includes the conjugated nodes corresponding to the arcs 64 whose use depends on clearance.

In other words, this optional addition consists in a pretreatment processing of the particular zones of the airport, in particular the runway crossings and the parking spaces. A runway strip may be traversed only if it is explicitly requested in the clearance acquired. In order to facilitate the management of this constraint, the portions of the initial graph 38 corresponding to a runway crossing, are in the conjugated graph 39C, isolated and identified with the name of the runway crossing. The taxiing at the airport is undertaken via the taxiways 20, it being possible to use the parking spaces only for the start and/or the end of the paths. In other words it is prohibited to ‘cut’ through the parking spaces. In order to facilitate the management of this constraint, the portions of the initial graph 39 Corresponding to the parking areas are in the conjugated graph 39C, isolated from the rest of the conjugated graph 39C.

This structuring into two subsets makes it possible, upon receiving of the clearance, and prior to the calculation of the taxi trajectory, to filter within the optional sub-graph the elements that are not allowed on the basis of the acquired clearance. The structuring thus then makes it possible to prohibit the crossing of runways and parking spaces that are not authorized by the clearance, and to limit the size of the conjugated graph 39C to be explored for the generation of the taxi trajectory, which greatly reduces the overall processing time and the amount of memory used.

As an optional addition with respect to the second example, during said determination step 124, the conjugated nodes are determined only for the arcs 64 of the initial graph 39 that are compatible with the dimensions (span, height) of the aircraft and/or with the acquired weight of the aircraft. The arcs 64 that are compatible with the dimensions of the aircraft are the arcs 64 that have no dimensional upper limit/bound or indeed the arcs for which the dimensional upper limit/bound is greater than the dimensions of the aircraft. In an analogous manner, the arcs 64 that are compatible with the weight of the aircraft are the arcs 64 which have no upper weight limit or the arcs for which the upper weight limit is greater than the weight of the aircraft.

This restriction of the conjugated nodes to only those arcs 64 that are compatible with the dimensions (wing span size, height) of the aircraft and/or with the weight of the aircraft is done via a prior filtering process; and conjugated nodes that are incompatible are not determined. Alternatively, all of the conjugated nodes are determined at an initial stage thereafter the conjugated nodes that are incompatible with the dimensions of the aircraft and/or the weight of the aircraft are then deleted, at a subsequent stage.

According to the second example, the acquisition step 120 thereafter includes the calculation 126 of the conjugated graph 39C by the calculation module 72, by connecting nodes together based on the links between the arcs 64 of the initial graph 39 and based on the authorized directions of navigation, two conjugated nodes connected to each other corresponding to two successive arcs 64 of the initial graph 39 and to a single authorized direction of navigation.

The person skilled in the art will understand then that all the paths 39C of the conjugated graph have associated therewith a single path of the initial graph 39. In other words, there's an injection of all of the paths defined by the conjugated graph 39C into all of the paths of the initial graph 39.

As an optional addition to the second example, during said calculation step 126, two conjugated nodes are connected to each other only when the two successive arcs 64 of the initial graph, identified by said conjugated nodes, form between them a bending radius that is greater than the minimum bending radius. This then makes it possible to remove the sequences of navigation arcs that are incompatible with the minimum turning radius of the aircraft. Alternatively of embodiment, all of the conjugated nodes are interconnected to each other in accordance only with the authorized direction at the initial stage thereafter the transitions between conjugated nodes that are incompatible with the minimum turning radius of the aircraft, are deleted, during a subsequent stage.

As another optional addition to the second example, during said calculation step 126, the calculation module 72 deletes each conjugated node having one single preceding conjugated node and one single subsequent conjugated node, the preceding conjugated node and the subsequent conjugated node of said deleted conjugated node being then connected directly to each other. This makes it possible to simplify the conjugated graph 39C, such a conjugated node having one single preceding conjugated node and one single subsequent conjugated node not being necessary for generating the taxi trajectory.

Thus, the transformation of the initial graph 39 into the conjugated graph 39C provides the ability to facilitate the integration of constraints related to the clearance and/or to the aircraft. To further facilitate the treatment and processing of traffic circulation constraints, the conjugated graph 39C is also structured between the permanent sub-graph that contains no conjugated node associated with a runway crossing, or the crossing of parking spaces, and the optional sub-graph including, on the one hand, the conjugated nodes associated with runway crossings 26, and on the other hand, the conjugated nodes associated with crossing of parking spaces.

The constraints likely to be taken into account in the conjugated graph 39C and which are not already present in the initial graph 39C in particular include the dimensions (wingspan, height) of the considered aircraft, the weight (or the mass) of the considered aircraft, the minimum turning radius of the considered aircraft, the taxiways in operation, the gates reserved for certain types of aircraft.

The conjugated graph 39C then makes it possible, by taking account of these constraints, to prevent a taxi trajectory that is not compliant with one of these constraints from being generated and used by the pilot whereas this would be erroneous.

The person skilled in the art will note furthermore that it is possible for the steps 122 to 126 constituting the acquisition of the conjugated graph 39C are, with the exception of adaptation to the clearance, to be carried out in preprocessing phase, in particular prior to the step 110 of acquisition of the clearance. This makes it possible to move forward the computing time associated with less critical moments, or even to perform these calculations on the ground prior to the start of the engines of the aircraft.

The person skilled in the art will also understand that the calculation of the conjugated graph 39C is implemented at each change instituted in the airport navigation network 12B.

Alternatively, the calculation of the conjugated graph 39C is performed on the ground and the conjugated graph is stored directly in a database so as to subsequently be uploaded to the memory 17 of the electronic taxi trajectory generation system 10. This makes it possible to simplify and lighten the treatment and processing performed in the electronic generation system 10.

According to the second example, upon conclusion of the computing of the conjugated graph 39C 126, the method proceeds to the step 130, during which the conjugated entry 42C, exit 43C, departure 44C and arrival 45C nodes are determined based on the graph acquired, that is to say based on the conjugated graph 39C calculated in this case.

During the determination step 130, the determination device 40 determines, according to the first example of reception, when the initial graph 39 is compliant with the standard ARINC 816-2, the entry 42, exit 43, departure 44 and arrival 45 nodes directly based on said initial graph 39 received, this latter containing for each airport element the data and information relating to the nodes for entry into said element and for exit from said element. According to the second example, during the step of determination 130, the determination device 40 determines the conjugated entry 42, exit 43, departure 44 and arrival 45 nodes based on the calculated conjugated graph 39C. Each conjugated node corresponds to one single authorized direction of navigation, the determination device 40 determines said conjugated entry 42, exit 43, departure 44 and arrival 45 nodes based, on the one hand, on the single authorized direction of navigation associated with each of the conjugated nodes, and on the other hand, on the direction of movement from the departure element 34 to the arrival element 35 of the clearance acquired 32.

As an optional addition to the second example, the conjugated nodes 42C, 43C, 44C, 45C corresponding to a single given element 34, 35, 36 of clearance are also grouped together with each other.

After the step of determination 130, the first calculation device 46 calculates, during the step 140, the external paths 48 and the internal path(s) 52.

The calculation step 140 then includes a step 48 for calculating the external paths 142 and/or the step 144 for calculating the internal path(s) 52.

During the calculation step 142, the first calculation device 46 thus then calculates, in the acquired graph 39, 39C, each external path 48 connecting an exit node 43, 43C associated with an element of the clearance to an entry node 42, 42C associated with the element following said element in the clearance, by passing through one or more arcs, each departure node 44, 44C forming an exit node 43 43C and each arrival node 45, 45C forming an entry node 42, 42C, as shown in FIG. 5.

During the calculation step 144, the first computing device 46 also calculates, in the acquired graph 39, 39C, each internal path 52 connecting, for a corresponding intermediate element 36, the entry nodes 42, 42C and exit nodes 43, 43C of said intermediate element 36 by passing through one or more arcs.

The step of calculation of the external paths 142 for example, is carried out prior to the step of calculation of the internal path(s) 144 step. Alternatively, the step of calculation of the internal path(s) 144 is carried out prior to the step of calculation of the external paths 142.

Alternatively, the step of calculation of the external paths 142 and/or the step of calculation of the internal path(s) 144 are carried out on a preliminary basis, prior to the step 110 of acquisition of the clearance, and these steps are thus then performed for all of the elements of the clearance associated with the airport area 12A, and not only for the elements of the acquired clearance 32. The calculated external 48 and/or internal 52 paths are then stored in the memory 17. This then makes it possible to reduce the time required for the calculation of the global path 56 from the time instant where the clearance 32 is acquired, and thus to more quickly generate the taxi trajectory 11. The fact that the computational time required for the steps of calculation 142, 144 will be longer according to this variant, it being given that the path calculations are performed on all of the elements of clearance, and not only on the elements of the acquired clearance 32 is not detrimental, since these steps of calculation 142, 144 are indeed performed initially, and for example, by an information processing unit that is external to the aircraft.

During the step carried out at first among the step of calculation of the external paths 142 and the step of calculation of the internal path(s) 144, the calculated paths 48, 52 have, in accordance with a predetermined cost function, a minimum value. In other words, the first computing device 46 calculates, during said step carried out at first among the steps 142 and 144, the corresponding shortest path(s).

During the step carried out at second among the step of calculation of the external paths 142 and the step of calculation of the internal path(s) 144, the paths 48, 52 are calculated so as to be compatible with the shortest path(s) calculated at first, that is to say they connect the entry 42, 42C and exit 43, 43C nodes belonging to the shortest paths calculated at first.

As an optional addition, the first computing device 46 calculates during the steps 142 and/or 144, multiple external paths 48 and/or internal paths 52 respectively, for at least one transition. In other words, the first computing device 46 calculates multiple shortest paths for at least one transition during these steps 142 and/or 144. The plurality of external paths 48 and/or internal paths 52 respectively, calculated for the relevant transition considered then corresponds to the minimum values obtained for said transition in accordance with a predetermined cost function.

During the steps 142 and 144, the paths 48, 52 are for example calculated via a corresponding algorithm for searching for the shortest path in a graph, such as Dijkstra's algorithm, the DLU algorithm or even the A* algorithm. Dijkstra's algorithm is used preferentially during the steps of calculation 142 and 144.

Following the step 140 of calculation of the internal path(s) and external paths, the second computing device 54 calculates during the step 150, the global path 56 between the corresponding departure nodes 44, 44C and arrival nodes 45, 45C from the internal path(s) 52 and external paths 52 58 previously calculated during the calculation steps 142 and 144. The calculated global path 56 then consists of internal path(s) 52 and external paths 58 previously calculated during the calculation steps 142 and 144. The global path 56 is also calculated via a corresponding algorithm for searching for the shortest path, such as Dijkstra's algorithm, the DLU algorithm or even the A* algorithm. The A* algorithm is used preferentially during the calculation step 150.

As an optional addition, the generation method according to the invention includes multiple iterations of the steps for calculating external paths 142, for calculating the internal path(s) 144, and for calculating the global path 150, and the method then includes at the end of step 150, a step 160 during which the generation system 10 determines whether or not a new iteration is needed. During this step of determining 160, the generation system 10 determines whether a reiteration is necessary based on whether or not a predefined criterion has been met, and whether there still remains at least one transition for which a shortest path has not yet been found.

The predefined criterion is, for example, a maximum value in accordance with a predetermined cost function of the calculated global path 56. In other words, according to this criterion, a new iteration is necessary as long as the value according to the cost function of the last calculated global path 56 is greater than said maximum value, and if there still remains at least one transition for which a shortest path has not yet been found.

Alternatively, the predefined criterion is to continue as long as a global path has not been determined, with on an optional basis, a maximum number of iteration loops.

When a new iteration is required, the generation system 10 then returns to the step 140 in order to calculate new external 46 and/or internal 52 paths.

During a new iteration, new external 46 and internal 52 paths are sought from among the paths other than those calculated during the preceding iteration(s).

Over the course of the new iteration, during the step carried out at first among the step of calculation of external paths 142 and the step of calculation of the internal path(s) 144, the new calculated path(s) 48, 52 have, in accordance with a predetermined cost function, a minimum value among the values of said other paths, the step of calculation of the global path 150 being then performed again so as to calculate a new global path 56 additionally based also on the new external 48 and internal 52 paths.

The new global path is then retained only if it has, in accordance with a predetermined cost function, a value that is less than that of the global path calculated during the preceding iteration(s). In addition, among the new external and internal calculated paths, only the paths used in the new global path 56 are retained, with the other path(s) from among said new external and internal paths being then ignored.

A new external or internal calculated path is capable of being an improvement over the global path 56 thus far only if the sum of the costs, in accordance with a predetermined cost function, of this new calculated global path and of the best paths for the transitions other than those corresponding to the new calculated path is less than the cost, according to said cost function, of the global path 56 calculated thus far, that is to say of the global path 56 calculated during the preceding iteration.

The person skilled in the art will observe also that the shortest global path 56 with respect to the predetermined cost function does not necessarily pass through the paths that for each transition are the shortest with respect to said cost function. The step of calculation of the external paths 142 is for example, at each iteration, carried out prior to the step of calculation of the internal path(s) 144. Alternatively, the step of calculation of the internal path(s) 144 is at each iteration, carried out prior to the step of calculation of the external paths 142.

When the generation system 10 determines, during the step 160, that a new iteration is not necessary, the generation system 10 then passes on to the next step 170, during which the generation device 58 generates the taxi trajectory 11 based on the best global path 56 calculated in step 150. The generation device 58 then reconstructs the trajectory in the airport area 12A by passing through the corresponding navigation arcs 64, in the initial graph 39 according to the first example, or in the conjugated graph 39C according to the second example, to the best calculated global path 56.

As an optional addition, the generation device 58 transmits in addition, during the step 170, the taxi trajectory 11 to the display screen 15 in order to ensure that the display thereof is available to the crew of the aircraft or to an operator in a control tower. Alternatively or in complement thereto, the generation device 58 transmits the taxi trajectory 11 generated to a corresponding on-board avionics system.

In addition, the generation of the taxi trajectory based on the acquired clearance makes it possible to extend across the ground areas the management of the aircraft with the avionics, in order to improve the flow of traffic in the airport area 12A.

In addition furthermore, the generation of the taxi trajectory based on the acquired clearance makes it possible to establish and implement appropriate warning systems in order to reduce the risk of accidents on the ground (runway incursion, collisions and mishaps, etc.).

In addition furthermore, the generation of the taxi trajectory based on the acquired clearance makes possible the determination of the taxiing time and therefore the management of the aircraft all throughout its scheduled flight mission from a boarding gate at departure right up to a landing-disembarkation gate upon arrival.

The trajectory generation system 10 makes it possible to calculate the shortest path, in accordance with a predetermined cost function, in the graph 39, 39C with the constraints of obligatory passage through certain elements of the airport area 12A, corresponding to the elements of the acquired clearance 32.

The trajectory generation system 10 then makes it possible to decompose the problem of searching for the shortest path into an ordered series of sub problems, by searching first for either the shortest external paths 48, or the shortest internal paths 52.

This decomposition into sub problems, that is to say the calculation of the external paths 48, on the one hand, and of the internal path(s) 52, on the other hand, then provides the ability to reduce the processing time required by the information processing unit 14, as well as the amount of memory space 17 used, in order to calculate the best global path 56, and then generate the taxi trajectory 11.

The person skilled in the art will understand that the generation method according to the invention then for example implements the heuristics based on which the shortest global path passes through the shortest transitions between each element of the clearance, that is to say, the heuristics consisting of favoring the shortest paths for each transition. This is optional.

The generation method is further optimized by calculating the external 48, internal 52 and global 56 paths in an incremental fashion in the form of a plurality of iterations each iteration including a step of calculation of the external paths 142, a step of the calculation of the internal path(s) 144 and a step of calculation of the global path 150. This incremental calculation then makes it possible to further reduce the overall processing time, as well as the amount of memory space used.

It may thus be conceived that the generation method and system 10 according to the invention makes it possible to improve the taxiing path generated 11, the latter being for example shorter and/or less fuel-intensive.

1. A method for generating a taxi trajectory of an aircraft in an airport area, the method being implemented by a computer and including:
an acquisition of a clearance that includes a departure element, an arrival element, and at least one intermediate element of the airport area that the aircraft must follow between the departure element and the arrival element;
an acquisition of a graph corresponding to an airport navigation network, the navigation network being associated with the airport area, said graph including a plurality of arcs, each arc having two end nodes;
a determination, based on the acquired graph, of at least one entry node and at least one exit node for each intermediate element of the clearance, of at least one departure node for the departure element, and at least one arrival node for the arrival element;
a calculation, in the acquired graph, of a plurality of paths external to the elements of the clearance and a calculation, in the acquired graph, of at least one path internal to each intermediate element of the clearance;
each external path connecting an exit node of an element of the clearance to an entry node of the element following said element in the clearance, each departure node forming an exit node and each arrival node forming an entry node;
each internal path connecting, for a corresponding intermediate element, the entry node and the exit node of said intermediate element, by passing through one or more arcs; and
during the operation carried out at first among the calculation of the external paths and the calculation of the internal path(s), the calculated path(s) have a minimum value in accordance with a predetermined cost function;
a calculation of a global path between the corresponding departure nodes and arrival nodes, based on the calculated internal path(s) and external paths; and
a generation of the taxi trajectory based on the calculated global path.

2. The method according to claim 1, wherein the method includes several iterations between the determination of the entry node and exit node and the generation of the taxi trajectory, each iteration including a calculation of the external paths (142), a step of calculation of the internal path(s) and a step of calculation of the global path,
during a new iteration, a search is carried out for the new external and internal paths among the paths other than those calculated during the preceding iteration(s), and
over the course of the new iteration, during the operation carried out at first among said calculation of the internal path(s) and said calculation of external paths, the new calculated path(s) have, in accordance with the predetermined cost function, a minimum value among the values of said other paths, the calculation of the global path being then performed again in order to calculate a new global path based in addition on the new external and internal paths.

3. The method according to claim 2, wherein the new global path is retained only if it has, in accordance with the predetermined cost function, a value that is less than that of the global path calculated during the preceding iteration(s).

4. The method according to claim 3, wherein among the new external and internal calculated paths, only the path(s) used in the new global path are maintained, the other path(s) from said new external and internal paths being then ignored.

5. The method according to claim 2, wherein the calculation of the external paths is, at each iteration, carried out prior to the calculation of the internal path(s).

6. The method according to claim 2, wherein the calculation of the internal path(s) is, at each iteration, carried out prior to the step of calculation of the external paths.

7. The method according to claim 2, wherein the cost function associated with a path is selected from the group consisting of the curvilinear length of the path, the amount of fuel consumed on said path, a representative function of a congestion on said path, a representative function of a risk of accident on said path, a representative function of the travel time on said path, and a function combining the above cited functions.

8. The method according to claim 1, wherein the acquisition of the graph includes the receiving of an initial airport navigation graph, said initial graph including a plurality of navigation arcs, each navigation arc having two end nodes and presenting at least one authorized direction of navigation.

9. The method according to claim 8, wherein the initial airport navigation graph then forms the acquired graph, the determination of the entry nodes and the exit nodes, the calculation of the external paths and internal path(s) and the calculation of the global path being then carried out based on the initial airport navigation graph.

10. The method according to claim 8, wherein the acquisition of the graph also includes:
a determination of a conjugated node for each navigation arc and for each authorized direction of navigation of said arc, each conjugated node corresponding to a single authorized direction of navigation and representing said arc of the initial graph associated with said authorized direction of navigation; and
a calculation of a conjugated graph including conjugated arcs connecting the conjugated nodes on the basis of the links between the arcs of the initial graph and the authorized directions of navigation, two conjugated nodes connected to each other corresponding to two successive arcs of the initial graph and to a single authorized direction of navigation; and
wherein the conjugated graph then forms the acquired graph, the determination of the entry and the exit nodes, the calculation of the external paths and internal path(s), and the calculation of the global path being then carried out based on the conjugated graph.

11. The method according to claim 10, wherein the acquisition of the graph also includes a classification of the conjugated nodes determined into first and second distinct subsets, the first subset including the conjugated node(s) corresponding to the arcs that are navigable for any clearance and the second subset including the conjugated nodes corresponding to the arcs that are navigable only for one or more clearances.

12. The method according to claim 11, wherein the conjugated nodes corresponding to a single element of the clearance are also grouped together with each other.

13. The method according to claim 10, wherein the method includes an acquisition of at least one variable value relative to an aircraft considered selected from the group consisting of the weight of the aircraft and at least one dimension relative to the bulk of the aircraft; and
during the determining of the conjugated nodes, a conjugated node is determined for a respective arc only if said arc is compatible with the acquired variable value.

14. A computer program product including software instructions which, when they are executed by a computer, implement a trajectory generation method according to claim 1.

15. An electronic taxi trajectory generation system for generating a taxi trajectory of an aircraft in an airport area, the system comprising:
a first clearance acquisition device configured for acquiring a clearance including a departure element, an arrival element, and at least one intermediate element of the airport area that the aircraft must follow between the departure element and the arrival element,
a second acquisition device configured for acquiring a graph corresponding to an airport navigation network, the navigation network being associated with the airport area, said graph including a plurality of arcs, each arc having two end nodes,
a node determining device for determining, based on the acquired graph, at least one entry node and at least one exit node for each intermediate element of the clearance, at least one departure node for the departure element, and at least one arrival node for the arrival element,
a first computing device configured for calculating, in the acquired graph, a plurality of external paths that are external to the elements of the clearance and at least one internal path that is internal to each intermediate element of the clearance, each external path connecting an exit node of an element of the clearance to an entry node of the element following said element in the clearance, by passing through one or more arcs, each departure node forming an exit node and each arrival node forming an entry node, each internal path (52) connecting, for a corresponding intermediate element, the entry node and exit node of said intermediate element, by passing through one or more arcs, the path(s) calculated at first among the external paths, on one hand, and the internal paths, on the other hand, having a minimum value in accordance with a predetermined cost function,
a second computing device configured for calculating a global path between the corresponding departure nodes and arrival nodes based on the internal path(s) and external paths calculated by the first computing device, and
a taxi trajectory generation device for generating the taxi trajectory based on the global path calculated by the second computing device.
